(19) United States
(12) Patent Application Publication
(10) Pub. No.: US 2020/0229353 A1
(43) Pub. Date: Jul. 23, 2020

(54) PORTABLE FABRIC GRAIN BIN

(71) Applicants: Richard Carter, Tempe, AZ (US); Kevin Henderson, Great Bend, KS (US)

(72) Inventors: Richard Carter, Tempe, AZ (US); Kevin Henderson, Great Bend, KS (US)

(21) Appl. No.: 16/724,215

(22) Filed: Dec. 21, 2019

Related U.S. Application Data
(60) Provisional application No. 62/783,552, filed on Dec. 21, 2018.

(51) Int. Cl. A01F 25/18; A01F 25/20; B65D 88/52

(52) U.S. Cl. CPC A01F 25/183; B65D 88/52; A01F 25/2018

(57) ABSTRACT

A portable grain storage bin including a circular sidewall having a top edge and a bottom edge, a conical cover coupled to and extending upwardly and radially inwardly from the top edge of the circular sidewall, to an opening and a partial floor extending radially inwardly from the bottom edge of the circular sidewall and terminating at a free edge. The circular sidewall, conical cover and partial floor are movable between a collapsed configuration when empty and a deployed configuration when filled.

### CROSS-REFERENCE TO RELATED APPLICATIONS

This application claims the benefit of U.S. Provisional Patent Application No. 62/783,552, filed 21 Dec. 2018.

### FIELD OF THE INVENTION

This invention relates to lose material storage structures.

More particularly, the present invention relates to temporary and portable grain bins.

### BACKGROUND OF THE INVENTION

In the field of loose material storage, and particularly grain storage, price fluctuations and other considerations can make storing bulk grain after harvesting attractive. To most effectively market harvested grain, the grain may need to store into summer and possibly into the next year. To do so, the grain will need to be stored properly. Grain is typically stored in fixed silos (bins), either privately owned or a third party. Bag silo are also commonly used to store grain. Some advantages of using a fixed silo over a bag silo for grain storage are that fixed silos keep the grains safe longer, and fixed silos can be equipped with complete temperature control and ventilation systems that guarantees the maintenance of the grain in good conditions. The problems with fixed silos is that each year, growers spend countless hours making costly and time-consuming trips to their bin site or third-party grain handling facilities. Additionally, they are costly, and cannot be relocated when desired. Grain storage bags are often used when harvests are large and the fixed facilities fill up. Grain storage bags can also, save time and money because they can be filled and stored in the field or other conveniently located area. This allows direct control of the grain inventory, with no third-party intervention and no additional storage, loading or unloading fees. Drawbacks include lack of airflow, unwieldiness with the propensity to tear and split. Furthermore, these bags are one use and made of plastic. One of the biggest drawback with grain bags is the bag itself. Each year a huge amount of plastic is used in one use brain bags. This large amount of plastic must then be disposed of when the grain is removed.

It would be highly advantageous, therefore, to remedy the foregoing and other deficiencies inherent in the prior art.

An object of the present invention is to provide a portable storage bin for loose material such as grain.

Another object of the present invention is to provide a portable grain storage bin which can be re-used and relocated.

Yet another object of the present invention is to provide a portable storage bin which can be aerated.

### SUMMARY OF THE INVENTION

Briefly, to achieve the desired objects and advantages of the instant invention, provided is a portable grain storage bin. Portable grain storage bin includes a body fabricated from reinforced fabric and movable between a collapsed configuration and a deployed configuration. The body includes a circular sidewall having a top edge and a bottom edge, a conical cover coupled to and extending upwardly and radially inwardly from the top edge of the circular sidewall to an opening, and a partial floor extending radially inwardly from the bottom edge and terminating at a free edge. At least one opening is formed in the circular sidewall. A sleeve extends outwardly from the circular sidewall and encloses the opening. A bottom pipe is inserted through the sleeve and extends radially inwardly. The bottom pipe includes small holes through a first side thereof, the small holes having a smaller diameter than a loose material being stored, and large holes through a second side thereof, the large holes having a diameter larger than the diameter of the loose material being stored.

Also provided is a method for storing loose material, such as grain, within a portable storage bin. The method includes the steps of providing a body fabricated from reinforced fabric and movable between a collapsed configuration and a deployed configuration, the body including a circular sidewall having a top edge and a bottom edge, a conical cover coupled to and extending upwardly and radially inwardly from the top edge of the circular sidewall to an opening, and a partial floor extending radially inwardly from the bottom edge and terminates at a free edge. The method further includes lifting the body at a portion of the conical cover adjacent the opening to move the body from the collapsed configuration to a partially deployed configuration. Filling the body with loose materials to be stored through the opening in the conical cover until the body moves to the deployed configuration. In the deployed configuration, the loose material to be stored covers the partial floor holding it in place.

### BRIEF DESCRIPTION OF THE DRAWINGS

The foregoing and further and more specific objects and advantages of the invention will become readily apparent to those skilled in the art from the following detailed description of a preferred embodiment thereof, taken in conjunction with the drawings in which:

FIG. 1 is a perspective side view of a portable grain bin according to the present invention;

FIG. 2 is a sectional side view of the portable grain bin of FIG. 1;

FIG. 3 is an enlarged partial view of an auger coupled to the top of a portable grain bin;

FIG. 4 is an enlarged partial view of an auger coupled to the top of a portable grain bin without a perforated pipe;

FIG. 5 is a side view of a portable grain bin in the collapsed configuration;

FIG. 6 is a side view of a portable grain bin in the partially deployed configuration;

FIG. 7 is a side view of a portable grain bin in the fully deployed configuration;

FIG. 8 is a side view of the portable grain bin encircled with a support system; and

FIG. 9 is a side view of the portable grain bin encircled with another support system.

### DETAILED DESCRIPTION OF A PREFERRED EMBODIMENT

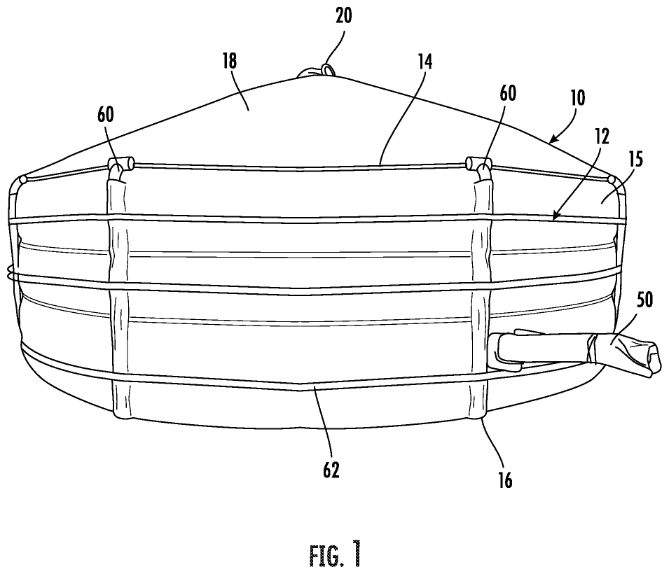

Turning now to the drawings in which like reference characters indicate corresponding elements throughout the several views, attention is directed to FIG. 1 which illustrates a portable grain bin generally designated 10. Portable grain bin 10 includes a body 12 fabricated from reinforced fabric. The fabric employed can be selected from many natural materials such as coated canvas and synthetic materials. Preferable materials are any reinforced industrial fabrics, including woven coated polyethylene and polypropylene, reinforced vinyl, coated polyester fabrics and the like. The fabric employed is flexible to permit collapse or folding of body 12 to a manageable size for portability. Body 12 is transformable from a collapsed configuration when empty to a deployed configuration when filled, and is preferably constructed from fabric material into a one-piece assembly. In the collapsed configuration, body 12 can be folded or rolled into a compact package for portability. Body 12 can be provided in multiple pieces, however the multiple pieces are designed to be easily put together. Portable grain bin 10 is lighter than conventional structures thus making it easier to move and set up.

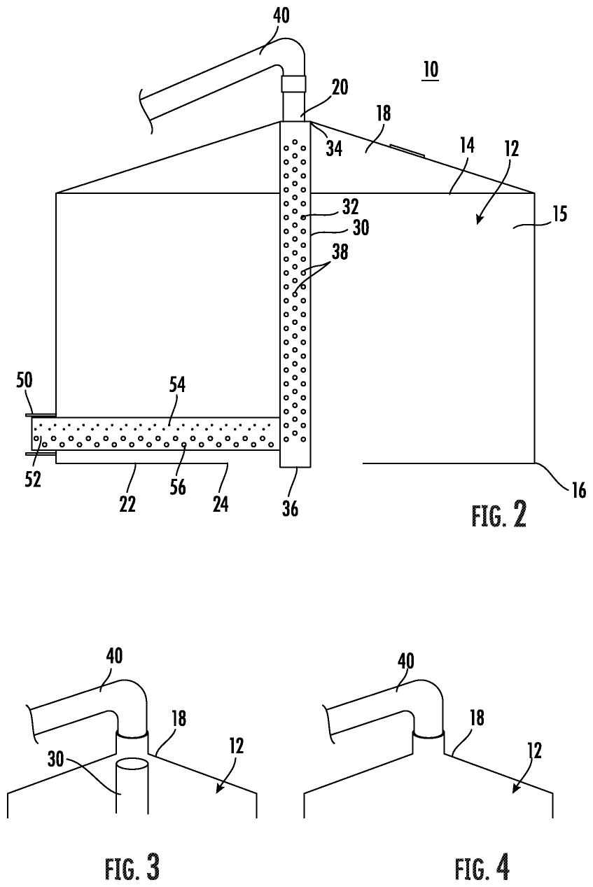

Still referring to FIG. 1, with additional reference to FIG. 2, body 12 includes a circular sidewall 15 having a top edge 14 and a bottom edge 16, and a conical cover 18, coupled to and extending upwardly and radially inwardly from top edge 14 of circular sidewall 15. Cover 18, when fully deployed, has the shape of an inverted funnel, including a centrally located opening 20. A partial floor 22 extends radially inwardly from bottom edge 16 and terminates at a free edge 24. FIG. 1 illustrated grain bin 109 with body 12 in the fully deployed configuration, filled with a stored material such as grain. Partial floor 22, extending from the outside perimeter towards the center is important in that when body 12 fills, grain is first deposited on partial floor 22. The weight of the grain on partial floor 22 keeps circular sidewall 15 in place by not allowing bottom edge 16 to push outwardly under the weight of the grain. The pressure of grain on a wall is greatest at the bottom. The amount of pressure is determined by the height of circular sidewall 15 multiplied by 23 pounds (assuming grain fills body 12 to the height of the sidewall). Therefore a 6′ high wall would exert 23 pounds times 6 feet or 138 psf (Pounds per square foot) at the bottom. Therefore, a fabric which is rated for greater than 138 psf is required. Based on these calculations, the diameter of body 12 should have minimal bearing on the pressure put on circular sidewalls 15. Consequently, the pressure on a 20′ diameter body 12 will be the same on a 100′ diameter body 12.

Referring specifically to FIG. 2, in the preferred embodiment, portable grain bin 10 includes a perforated pipe 30 having a lumen 32 extending between an upper end 34 and a lower end 36. A plurality of perforation 38 larger than the grain being stored are formed in perforated pipe 30 in communication with lumen 32. Perforated pipe 30 extends from a surface underlying body 12 to conical cover 18 adjacent opening 20, with opening 20 aligned with lumen 32 at upper end 34. In this embodiment, perforated pipe 30 supports conical cover 18 when body 12 is empty. Grain or other materials to be stored are introduced through opening 20 into lumen 32 at upper end 34 of perforated pipe 30, typically by a raiseable auger 40, well known in the industry. As the grain or other material falls toward lower end 36, the grain or other material exits perforations 38. Perforations 38 allow grain to distribute evenly out of perforated pipe 30 when filling. As can be seen in FIG. 2. Body 12 is supported in a partially deployed position wherein the conical cover 18 is held up by perforated pipe 30. With reference to FIG. 3, conical cover 18 can be attached to the dispensing end of auger 40, aligned with opening 20. Raising auger 40 will then lift conical cover 18 upwardly to the partially deployed configuration at which time perforated pipe can be positioned. FIG. 4 illustrates conical cover 18 attached to the dispensing end of auger 40, aligned with opening 20. Raising auger 40 will then lift conical cover 18 upwardly to the partially deployed configuration. In this example, perforated pipe is omitted and the grain is allowed to fill body 12 without guidance.

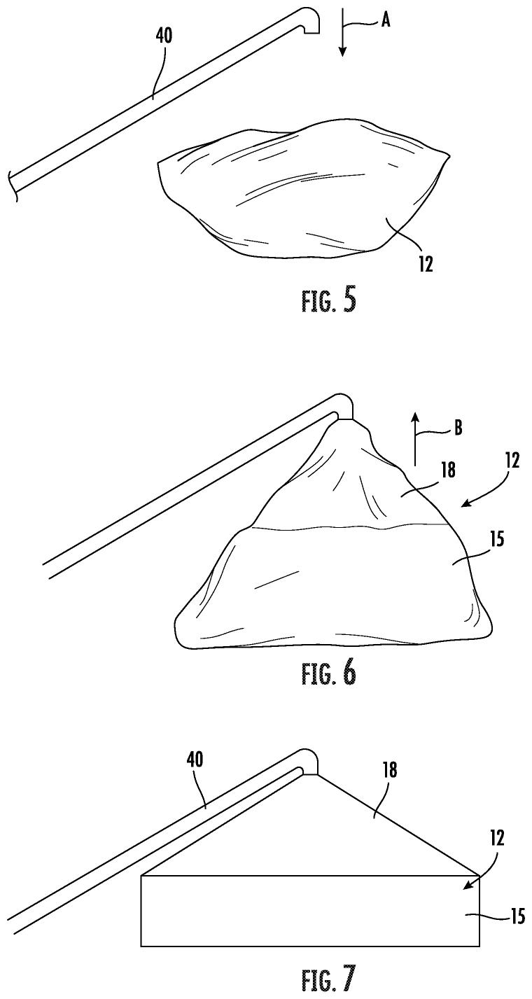

Turning now, to FIGS. 5-7, a simplified drawings of portable grain bin 10 are illustrated. In FIG. 5, body 12 is illustrated in a collapsed configuration ready to be deployed. Auger 40 will be lowered in the direction of arrowed line A for attachment to body 12. In FIG. 6, auger 40 has been coupled to body 12 at conical cover 18 and raised in the direction of arrowed line B. Raising auger 40 lifts conical cover 18 and supports body 12 in a partially deployed configuration. Grain is loaded into body 12 through auger 40 until filled and in a fully deployed configuration, as shown in FIG. 7. As discussed previously, perforated pipe 30 may or may not be used. Auger 40 can then be detached from conical cover 18. Body 12 is supported in the fully deployed configuration by the grain or other material being stored.

Referring back to FIGS. 1 and 2, one or more openings with protruding sleeves 50 extend out from circular sidewall 15 proximate bottom edge 16. Sleeves 50 are used for emptying body 12 and for blowing/sucking air for drying grain held therein. One or more bottom pipes 52 are positioned prior to filling body 12. A bottom pipe 52 is inserted through sleeve 50 and extending radially inwardly. Bottom pipe 52 includes small perforated holes 54 (having a smaller diameter than the material, such as grain, stored therein) on one side and large holes 56 (having a larger diameter than the material, such as grain, stored therein) on the other side. When bottom pipe 52 is inserted small holes 54 face upward to keep grain from filling bottom pipe 52 but allow air to be moved evenly into body 12. When it becomes time for body 12 to be emptied, an auger is put into bottom pipe 52 and then bottom pipe 52 is turned with large holes 56 facing upward. This allow grain to enter bottom pipe 52 and enter the auger which pulls the grain out of body 12.

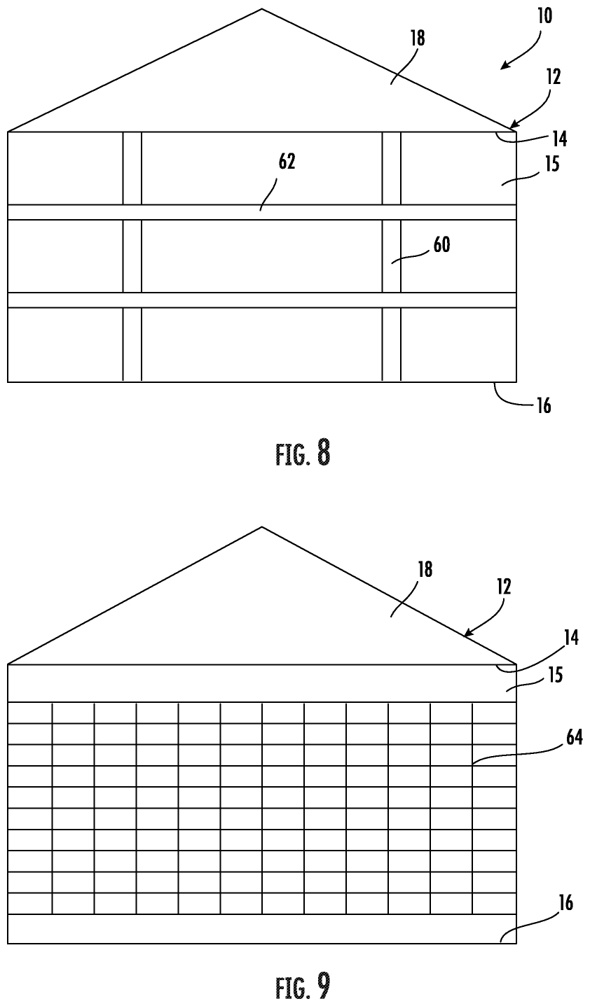

With continued reference to FIG. 1, and additional reference to FIGS. 8 and 9, sidewall support systems can be employed. While the pressure generated on the bottom edge 16 was described previously, there is also pressure on sidewall 18 above bottom edge 16. This pressure can be calculated in the same way, so at the 5′ level from the top the pressure would be 5 ft×23 lbs=115 psf and at 4 ft×23 lbs=92 psf. While the weight of the grain on the partial floor 22 hold bottom edge 16 in place, bulging may occur around the girth of body 12. Bulging can be minimized by using heavy fabric or by using some vertical and/or horizontal support structure. With reference to FIGS. 1 and 8, a support structure can be provided including ribs 60 made of rigid materials such as PVC pipes, metal pipes, wood slats, metal slats, plastic slats, rods, and the like, and straps 62 encircling body 12 including ribs 60. Straps 62 can be tightened with a ratchet. Another example of a support structure is illustrated in FIG. 9. In this example, a grid 64, similar to a chain link fence or a wire grid as used in concrete reinforcement, can be employed. Thus, wires or cords can be used to form a mesh or grid encircling body 12 and providing support thereto. This support structure does not have to be substantial since the fabric is doing most of the containment.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A portable grain storage bin comprising:
a circular sidewall having a top edge and a bottom edge;
a conical cover coupled to and extending upwardly and radially inwardly from the top edge of the circular sidewall, to an opening;
a partial floor extending radially inwardly from the bottom edge of the circular sidewall and terminating at a free edge;
wherein the circular sidewall, conical cover and partial floor are movable between a collapsed configuration and a deployed configuration.

2. The portable grain storage bin as claimed in claim 1 wherein the circular sidewall is formed from reinforced fabric rated for greater than 138 psf.

3. The portable grain storage bin as claimed in claim 1 further including at least one opening is formed in the circular sidewall and a sleeve extends outwardly from the circular sidewall enclosing the opening.

4. The portable grain storage bin as claimed in claim further including a bottom pipe inserted through the sleeve and extending radially inwardly, the bottom pipe including small holes through a first side thereof, the small holes having a smaller diameter than a loose material being stored, and large holes through a second side thereof, the large holes having a diameter larger than the diameter of the loose material being stored.

5. The portable grain storage bin as claimed in claim further comprising a perforated pipe having a lumen extending between an upper end and a lower end thereof, a plurality of perforation is formed in the perforated pipe between the upper end and the lower end in communication with the lumen, the perforated pipe extending between a surface upon which the bin rests and the opening in the conical cover, with the opening aligned with the lumen at the upper end.

6. The portable grain storage bin as claimed in claim 1 further comprising a sidewall support structure.

7. The portable grain storage bin as claimed in claim 6 wherein the sidewall support structure further comprises a plurality of ribs spaced apart around the circular sidewall and each extending vertically between the top edge and the bottom edge thereof, and at least one tightenable strap encircling the circular sidewall and encompassing the ribs.

8. The portable grain storage bin as claimed in claim 6 wherein the sidewall support structure further comprises a mesh or grid encircling the body providing support thereto.

9. A portable grain storage bin comprising:
a body fabricated from reinforced fabric and movable between a collapsed configuration and a deployed configuration, the body including:
a circular sidewall having a top edge and a bottom edge;
a conical cover coupled to and extending upwardly and radially inwardly from the top edge of the circular sidewall to an opening;
a partial floor extends radially inwardly from the bottom edge and terminates at a free edge;
at least one opening formed in the circular sidewall; and
a sleeve extending outwardly from the circular sidewall and enclosing the opening; and
a bottom pipe inserted through the sleeve and extending radially inwardly, the bottom pipe including small holes through a first side thereof, the small holes having a smaller diameter than a loose material being stored, and large holes through a second side thereof, the large holes having a diameter larger than the diameter of the loose material being stored.

10. The portable grain storage bin as claimed in claim 9 further comprising a perforated pipe having a lumen extending between an upper end and a lower end thereof, a plurality of perforation is formed in the perforated pipe between the upper end and the lower end in communication with the lumen, the perforated pipe extending between a surface upon which the body rests and the opening in the conical cover, with the opening aligned with the lumen at the upper end, wherein the perforated pipe evenly distributes loose material entering through the opening.

11. The portable grain storage bin as claimed in claim 9 further comprising a sidewall support structure.

12. The portable grain storage bin as claimed in claim 11 wherein the sidewall support structure further comprises a plurality of ribs spaced apart around the circular sidewall and each extending vertically between the top edge and the bottom edge thereof, and at least one tightenable strap encircling the circular sidewall and encompassing the ribs.

13. The portable grain storage bin as claimed in claim 11 wherein the sidewall support structure further comprises a mesh or grid encircling the body providing support thereto.

14. A method of storing grain in a portable storage bin comprising the steps of:
providing a body fabricated from reinforced fabric and movable between a collapsed configuration and a deployed configuration, the body including a circular sidewall having a top edge and a bottom edge, a conical cover coupled to and extending upwardly and radially inwardly from the top edge of the circular sidewall to an opening, and a partial floor extending radially inwardly from the bottom edge and terminates at a free edge;
lifting the body at a portion of the conical cover adjacent the opening to move the body from the collapsed configuration to a partially deployed configuration; and
filling the body with loose materials to be stored through the opening in the conical cover until the body moves to the deployed configuration, wherein the loose material to be stored covers the partial floor holding it in place.

15. A method as claimed in claim 14 further comprising the steps of:
providing at least one opening formed in the circular sidewall and a sleeve extending outwardly from the circular sidewall enclosing the opening;
inserting a bottom pipe through the sleeve and extending radially inwardly within the body, the bottom pipe including small holes through a first side thereof, the small holes having a smaller diameter than a loose material being stored, and large holes through a second side thereof, the large holes having a diameter larger than the diameter of the loose material being stored.

16. A method as claimed in claim 15 wherein the step of filling the body further comprising the step of rotating the bottom pipe with the small holes directed upwardly

17. A method as claimed in claim 16 further comprising the step of emptying the body by rotating the bottom pipe so that the large holes are directed upwardly, inserting an auger through the bottom pipe, and extracting from the bottom pipe with the auger the loose material falling through the large holes.

18. A method as claimed in claim 15 further comprising the step of encircling the filled body with a sidewall support structure.
